(19) United States
(12) Patent Application Publication
(10) Pub. No.: US 2009/0277531 A1
(43) Pub. Date: Nov. 12, 2009

(54) METHOD FOR FILLING AT LEAST ONE COMPRESSED GAS TANK WITH AT LEAST ONE GAS, CONNECTOR FOR CONNECTING TO AN OPENING OF A COMPRESSED GAS TANK, AND COMPRESSED GAS CYLINDER VALVE

(75) Inventors: Johann Pongraz, Duisburg (DE); Ulrich Klebe, Kerken (DE); Randolph Kunkel, Duisburg (DE)

Correspondence Address: YOUNG & THOMPSON, 209 Madison Street, Suite 500, ALEXANDRIA, VA, 22314, US

(73) Assignee: L'AIR LIQUIDE, SOCIETE ANONYME POUR L'ETUDE ET L'EXPLOITATION DES PROCEDES GEORGES CLAUDE, PARIS (FR)

(21) Appl. No.: 12/295,867

(22) PCT Filed: Apr. 3, 2007
(86) PCT No.: PCT/EP2007/002972

§ 371 Date: Mar. 9, 2009

(30) Foreign Application Priority Data
Apr. 7, 2006 (DE) 10 2006 016 554.3

(51) Int. Cl. B67C 3/00; F16K 27/00; F16C 11/04

(52) U.S. Cl. 141/4; 251/366; 403/33

(57) ABSTRACT

Method for filling at least one compressed gas tank with at least one gas, wherein a reference pressure gas tank is formed in which a measurement can take place of at least one measurement variable which is relevant for the state in the reference pressure gas tank, wherein the compressed gas tank and reference pressure gas tank are flow-connected at least at times, wherein each compressed gas tank and the reference pressure gas tank have in each case one opening through which a gas can be filled and extracted, wherein in a filling process, at least one gas is filled through the opening into the at least one compressed gas tank and at least at times into the reference pressure gas tank, is characterized in that a measuring sensor is inserted through the opening into the reference pressure gas tank, and at least one measurement variable is measured by the measuring sensor at least during a part of the filling process.

The subject matter of the present invention is a method for filling at least one compressed gas tank with at least one gas, a connector for connecting to an opening of a compressed gas tank, and a corresponding compressed gas cylinder valve. According to the invention, it is possible in particular to produce mixtures of gases whose ratios can be adjusted with high precision.

A method for mixing gases is known from the prior art EP 0 908 665 A2, in which a reference gas tank is filled in addition to the compressed gas tank to be filled. The reference gas tank has one or more additional holes in the casing of the compressed gas tank, through which measurement sensors can be introduced into the reference compressed gas tank. The filling is controlled appropriately on the basis of the measured values of these measurement sensors. The compressed gas tank to be filled and the reference compressed gas tank are in this case connected for flow purposes and are filled in parallel with one another such that the conditions in the reference compressed gas tank are essentially the same as those in the compressed gas tank to be filled.

This method known from the prior art has the disadvantage that the reference compressed gas tank is a specific reference compressed gas tank which must be produced by introducing additional holes into the tank and for which a safety test must be carried out. This test must, in particular, be carried out for each individual reference compressed gas tank. Special reference compressed gas tanks such as these can in some circumstances also not be handled in advance together with the tanks to be filled.

In contrast to this, the present invention is based on the object of providing a corresponding filling method in which a conventional compressed gas tank can be used as a reference compressed gas tank. A further aim is to specify a corresponding connector which allows this.

These objects are achieved by the features of the independent claims. The respective dependent claims are directed at advantageous developments.

The method according to the invention for filling at least one compressed gas tank with at least one gas, with a reference compressed gas tank being provided, in which a measurement of at least one measurement variable, which is relevant for the state in the reference compressed gas tank can be carried out, with the compressed gas tank and the reference compressed gas tank being connected for flow purposes at least at times, with each compressed gas tank and the reference compressed gas tank each having an opening through which they can be filled with a gas and the gas can be removed, with at least one gas being passed during a filling process through the opening into the at least one compressed gas tank and at least at times into the reference compressed gas tank, is distinguished in that a measurement sensor is introduced through the opening into the reference compressed gas tank, and this measurement sensor is used to measure at least one measurement variable at least during a part of the filling process.

According to the invention, the reference compressed gas tank is distinguished in that a normal compressed gas tank without any additional holes can be used as the reference compressed gas tank and, in particular in precisely the same way as the compressed gas tanks to be filled, has only one opening through which it is filled with gas and gas is removed in the normal manner. In particular, the reference compressed gas tank and the compressed gas tanks to be filled are compressed gas cylinders which, depending on the version, can withstand, for example, pressures of up to 200 bar or even 300 bar or more, with different volumes in the normal commercial manner. When two elements are connected for flow purposes, this means that a gas can flow from one element to the other without, for example, being impeded by walls or the like. By way of example, a measurement sensor means an active or passive sensor. The active sensor must in this case be operated actively, for example by being supplied with electrical current, or comprises electronic appliances for evaluation of the measurements, while the passive sensor provides just one variable which allows conclusions to be drawn about the measurement variable to be measured. For example, a passive sensor is a temperature-sensitive resistor or a light-sensitive resistor. An active sensor, for example, is a so-called “lab on a chip” in which all of the analytical equipment is provided on a miniature scale, and from which the measurement results can be tapped off.

In this case, in one preferred refinement, the measurement sensor is a high-precision measurement sensor, in particular a high-precision pressure sensor. This is preferably a pressure sensor with an accuracy of <0.5 to 0.1%, in particular a low-pressure sensor with measurement ranges of 0 to 10 bar absolute, preferably 0 to 5 bar absolute, and in particular 0 to 2 bar absolute. This can be used particularly advantageously for high-precision metering of gas, in particular in the course of adjusting a gas mixture.

In one preferred refinement of the method according to the invention, at least one first component is first of all introduced up to a predeterminable first pressure, which is monitored by a measurement sensor which is correspondingly in the form of a low-pressure sensor. If necessary, this is then followed by introduction of at least a further component, with the pressure being monitored. The last component, preferably the gas component which makes up the majority of the overall mixture, is preferably added gravimetrically, that is to say by monitoring the weight that is introduced. This can be done at pressures up to 100 bar, preferably up to 200 bar, and particularly preferably up to 300 bar, thus allowing high-precision gas mixtures to be produced with an accuracy of 1 to 2% up to four times more quickly than in the case of conventional gravimetric filling methods.

The method according to the invention is particularly suitable for filling a plurality of compressed gas tanks, for example from two to twelve or even more compressed gas tanks. In particular in this case, the compressed gas tanks can be filled not only with a single gas but also with two or more gases or gas mixtures successively. For example, this makes it possible to produce high-precision mixtures of a plurality of gases. The method according to the invention is particularly suitable for producing mixtures of two or more gases, in which one or more gases make up only a very low partial pressure in the final mixture. By way of example, one component may therefore have a partial pressure of only a few millibars while the other component may have a pressure of 100 bar or more. One particular advantage of the method according to the invention is that the reference compressed gas tanks and the compressed gas tanks to be filled have the same flow conductances. This is particularly true when the valve cross sections including the tube cross sections of the supply lines are the same, or differ only insignificantly from one another.

According to the invention, at least one measurement variable is measured by the measurement sensor at least during a part of the filling process. Particularly during filling with a plurality of gases, this means that the measurement variable is not necessarily measured during filling with each of the individual components. For example, when producing a mixture of two gas types, measurements can be carried out only during filling with one of the two gas types.

As a result of the flow connection at least at times between the compressed gas tank to be filled and the reference compressed gas tank, for example when the measurement variable is the pressure, this means that the pressure in the compressed gas tank or tanks to be filled is known at the same time, in addition to the pressure in the reference gas tank. Using high-precision pressure measurement sensors, in particular capacitive pressure sensors which are intended in particular for pressures of less than 1 bar, preferably of less than half a bar or even of 250 millibars or less, it is consequently possible to determine the exact amount of pressure in the compressed gas tanks to be filled. However, the amount of gas in these tanks is also known from the known pressures in the compressed gas tanks. Particularly when gas mixtures are being produced in which one gas component makes up only a very small proportion, for example in the region of a few percent, of less than 1 percent or even in the region of a few ppm (parts per million), or even a few ppb (parts per billion), this is advantageous since low pressures can be determined very accurately. By way of example, this may be done by means of capacitive pressure measurement systems. In contrast to this, accurate measurement is possible, for example, using gravimetric methods for very small proportions only with relatively large amounts, so that in this case, either a large error must be accepted in the creation of the gas mixtures or else a very large amount of gas must be produced, which must then be diluted. This latter method requires a multiplicity of large-volume intermediate tanks in which these individual gas mixtures are stored. This involves a large amount of hardware complexity and is associated with high costs if high-precision gas mixtures are intended to be produced in this way, and the present invention makes it possible to avoid this.

According to one advantageous development of the method according to the invention, the measurement variable comprises at least one of the following variables:
i) a pressure in the reference compressed gas tank;
ii) a temperature in the reference compressed gas tank;
iii) a chemical composition of a gas in the reference compressed gas tank; and
iv) a moisture content in the reference compressed gas tank.

The pressure in each compressed gas tank is at the same time known as a result of measurement of the pressure in the reference compressed gas tank when all of the compressed gas tanks to be filled are connected for flow purposes to the reference compressed gas tank. On the basis of the pressure, the relevant gas state equation can also be used to deduce the corresponding amount of the gas. If the reference compressed gas tank and the compressed gas tank to be filled have identical volumes, then there is an identical amount of gas in both tanks, as well, when the pressure is the same. In this case, particularly at low pressures, an ideal gas can be assumed, following the ideal gas law.

The measurement of the temperature in the reference compressed gas tank also allows more accurate determinations of the amount of gas in particular in conjunction with a pressure measurement, since the temperature allows the corresponding gas state equations to be evaluated even more accurately. The measurement of the chemical composition of a gas in the reference compressed gas tank can also be used to check the gas mixture to be set and, on the other hand, can also be used to detect impurities in the compressed gas tank and/or in the gas flowing in. The chemical composition can be analyzed by appropriate analytical measurement sensors, for example by means of so-called “lab on a chip” apparatuses. The moisture content in the reference compressed gas tank may be relevant, for example, when filling with gases or gas mixtures which react with water. For example, the moisture content is relevant and critical when the compressed gas tank or tanks is or are being filled with a gas comprising nitrogen monoxide. Alternatively or additionally, samples can also be taken from the reference compressed gas tank, with a small amount of gas being taken and analyzed externally. This may be, for example, a mass-spectrometric, spectral analysis, FTIR, GC and an NMR analysis, or some other analysis.

In this context, it is particularly preferable for the measurement sensor to be a capacitive pressure measurement sensor.

Capacitive pressure measurement sensors such as these measure the pressure locally applied to the sensor, by measurement of the electrical capacitance of a capacitor. These measurement sensors which, by way of example, are marketed under the name Compact Capacitance Diaphragm Gauge from the companies Pfeiffer or Alcatel, under the name Capacitron from the company Leybold and under the name Barocel 600-659 from the BOC Edwards company, allow high-precision measurement of the pressure, particularly at low pressures. In this case, a low pressure means in particular a pressure below atmospheric pressure or in the vicinity of atmospheric pressure, for example in the range from 10⁻³ mbar up to 10 bar. Capacitive pressure measurement sensors in particular also have the advantage that they can measure the pressure of widely differing gas types, that is to say they operate independently of the gas type. The measured value from a capacitive pressure measurement sensor such as this is therefore independent of the gas type, so that the measured values from the same pressure measurement sensor can be used, in particular without any further corrections, for filling with different gas types.

According to a further advantageous refinement to the method according to the invention, the filling process comprises a plurality of steps.

By way of example, a filling process comprising a plurality of steps means a filling process in which at least one pressure plateau occurs. In this case, a pressure plateau means a situation in which the pressure is kept essentially constant for a certain time period during the filling process. A further example of a filling process which comprises a plurality of steps is a filling process in which a specific partial pressure of a first gas component, for example nitrogen monoxide is reached first of all, followed by a partial pressure of a second gas component, for example nitrogen, in the compressed gas tank. Particularly in the case of filling processes which comprise a plurality of steps, it may be advantageous to at least partially evacuate the compressed gas tank or tanks and/or supply lines to the compressed gas tanks before or between the steps, in order to reduce impurities. In this case, evacuation means a pressure reduction.

According to a further advantageous refinement of the method according to the invention, the filling process is carried out at least at times as a function of the measurement variable. This means that the measurement variable is particularly advantageously used for open-loop or closed-loop control of the filling process. By way of example, this can mean that a gas valve which makes a connection to a gas reservoir or closes this connection is open until a pressure measurement sensor indicates an appropriate pressure, and the valve is closed after reaching this pressure. This can also mean, for example, that the filling process is being carried out in such a way that a temperature in the reference compressed gas tank and therefore also the temperature in the compressed gas tank or tanks to be filled is not above a predeterminable value, that is to say such that an appropriate inlet valve is closed when this temperature is reached and the valve is not opened again until a further pressure, which can be predetermined, is undershot. This can be particularly advantageous when gases or gas mixtures are being produced which are reactive above a specific temperature. The corresponding measured measurement variables can also be used to initiate warning functions. For example, if it is found that the moisture content is above a limit value and filling is being carried out with a gas which reacts with water, a corresponding warning indication can be emitted, for example a warning signal can be output. Alternatively or additionally, it is also possible to terminate the filling process in this case.

According to a further aspect of the present invention, a connector is proposed which is used for connecting to an opening of a compressed gas tank. The connector according to the invention comprises a first connection for connection of the connector to a compressed gas tank, a second connection for connection of the connector to a valve head, and is characterized in that at least one measurement sensor is provided and can be connected for flow purposes at least to the first connection.

In this case, a connection means a mechanical connection by means of which the connector can be connected to the respective element. In this case, for example, this may be a thread which can be connected to a component in particular with a pin or cone which has a corresponding thread, or else may be a compressed gas tank which has a corresponding thread, as is normal in the case of compressed gas cylinders. In this case, a valve head means a unit as is normally used for compressed gas cylinders. This is a valve wheel by means of which a corresponding valve body can be opened and closed, and a pressure measurement unit which indicates the pressure in the gas cylinder. Furthermore, the valve head may comprise a pressure reducer by means of which the pressure, which may be quite high in the compressed gas tank, is reduced to lower pressures, for example in the region of one bar or less. Furthermore, the valve head comprises a connection for a gas line by means of which gas can be removed from the compressed gas tank. In particular, a valve head may be a compressed gas tank valve.

It is particularly preferable to provide at least one measurement sensor in such a way that this measurement sensor passes through the first connection. This makes it possible to ensure that the measurement sensor projects into the compressed gas tank when the connector is connected to it, and therefore measures the measurement variable in the interior of the compressed gas tank. For example, this makes it possible for a corresponding temperature measurement head, for example in the form of a temperature-sensitive resistor or a thermocouple, to pass through the first connection therefore allowing the temperature in the interior of the compressed gas tank to be determined when the connector is fitted to a compressed gas tank. In a particularly advantageous manner, the connector according to the invention makes it possible to reuse the normal valve heads which are known for connection to and for removal of gas from the compressed gas tank. The connector according to the invention also has the advantage that there is no longer any need to provide a reference compressed gas tank which is different from conventional compressed gas tanks, but that it is possible to use a conventional compressed gas tank, for example a compressed gas cylinder, with the connector according to the invention as a reference compressed gas tank. This results in a cost advantage. Furthermore, there is no need for any additional safety approval for the reference compressed gas tank. In fact, the safety approval which is required in any case for the normal compressed gas tank is adequate in this case. Furthermore, in comparison to the system known from the prior art above, a reference compressed gas tank embodiment is therefore possible which can withstand even high pressures. This is normally not the case with the solution known from the prior art, with holes in the sides of the compressed gas tank. This advantageously even makes it possible to carry out measurements at high pressures in the interior of the reference compressed gas tank.

According to one advantageous refinement of the connector according to the invention, an extension is provided which extends through the first connection.

In this case, an extension means an elongated preferably metallic component. In the fitted state, the extension projects at least partially into the compressed gas tank.

One preferable feature in this context is that at least one of the measurement sensors is arranged on the extension, in particular in the area of the extension end.

In particular, a measurement sensor which measures the temperature can be arranged on the extension.

According to one advantageous development of the connector according to the invention, at least one of the following measurement sensors is provided:
i) a measurement sensor for determining the pressure in the reference compressed gas tank;
ii) a measurement sensor for determining the temperature in the reference compressed gas tank;
iii) a measurement sensor for determining a chemical composition of a gas in the reference compressed gas tank; and
iv) a measurement sensor for determining a moisture content in the reference compressed gas tank.

In particular, capacitive pressure measurement sensors or piezoelectric pressure measurement sensors can be used for pressure measurement. In particular, a measurement sensor for determining the temperature comprises a thermocouple or a temperature-sensitive resistor. A temperature-sensitive resistor measures only the resistance of the temperature-sensitive resistor, which varies as a function of the temperature on the temperature-sensitive resistor. In the case of a thermocouple, for example, a voltage is applied to a temperature-sensitive resistor and a current that flows is measured, and the instantaneous resistance is determined from this. The actual temperature can then be deduced from this.

A measurement sensor for determining a chemical composition may, for example, comprise a measurement sensor for measuring the proportion of one specific gas component. By way of example, this may be a Nernst probe, one of whose electrodes is at a corresponding reference. By way of example, this allows the moisture content in the reference compressed gas tank to be determined.

An embodiment of the connector according to the invention in which a capacitive measurement sensor is provided is particularly preferable.

According to a further advantageous refinement of the connector according to the invention, at least one transmission means is provided for transmission of at least one signal from a measurement sensor. For the purposes of this invention, a transmission means is a means which allows data to be transmitted to a corresponding receiver. In this case, the transmission may be either with or without the use of wires. The transmission means may accordingly be in the form of a plug or coupling to which a wire can be connected via which the corresponding measurement variable or signals generated by the measurement sensor are transmitted to a corresponding evaluation unit, such as an instrument or a controller. At the same time, wireless transmission is also possible, preferably based on electromagnetic waves, and particularly preferably based on electromagnetic waves in the radiofrequency or optical range. This particularly advantageously allows a single instrument to be used to monitor a multiplicity of measurement sensors in different connectors, in which case one central instrument interacts with a multiplicity of measurement sensors. In particular, this has the advantage that, if one connector is damaged, only one quite inexpensive element need be replaced, because the comparatively expensive evaluation electronics is not accommodated in the connector and need not be replaced. For example, this allows a thermocouple or a temperature-sensitive resistor for measurement of the temperature to be connected via an appropriate cable to an appropriate ohmmeter, voltmeter or an appropriate evaluation element.

Furthermore, a compressed gas cylinder valve is proposed which comprises a connector according to the invention as well as a valve head of a normal type.

The details and advantages disclosed in the course of this invention for the method according to the invention can be transferred and applied to the connector according to the invention. This also applies to the details and advantages disclosed in the course of the description of the connector according to the invention, which can be transferred and applied to the corresponding method in the same way. The connector according to the invention can advantageously be used in the course of the method according to the invention in which, specifically, the reference compressed gas tank has a connector according to the invention.

The invention will be explained in more detail in the following text with reference to the attached figures, without the invention being restricted to the exemplary embodiments illustrated there.

In the figures:

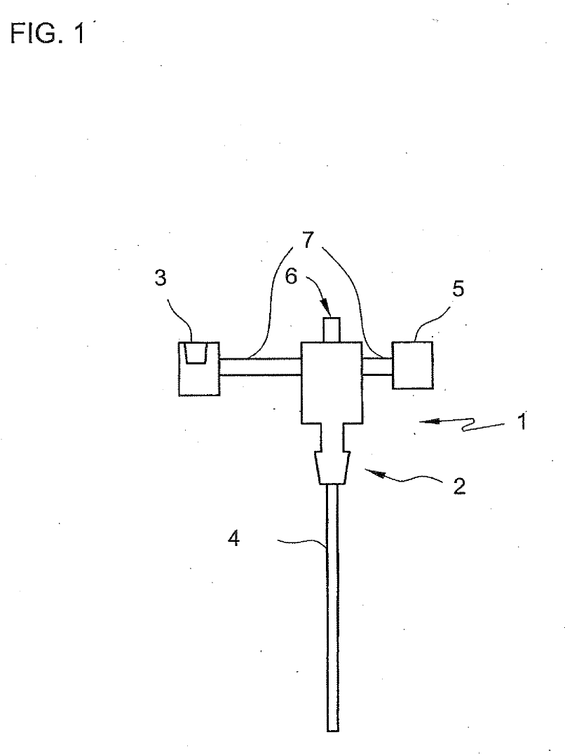

FIG. 1 shows, schematically, one exemplary embodiment of a connector according to the invention;

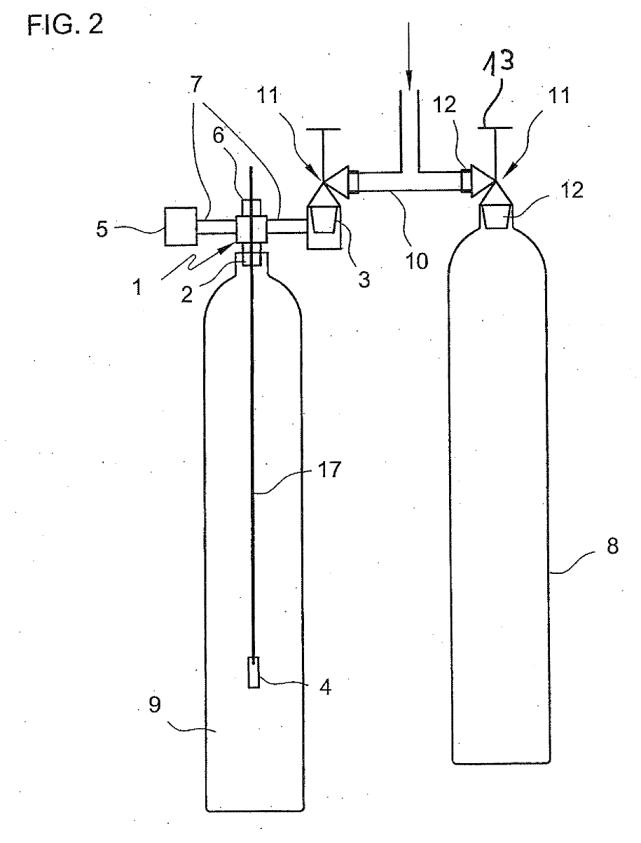

FIG. 2 shows, in a schematic form, a compressed gas tank equipped with a connector according to the invention for use in the method according to the invention; and

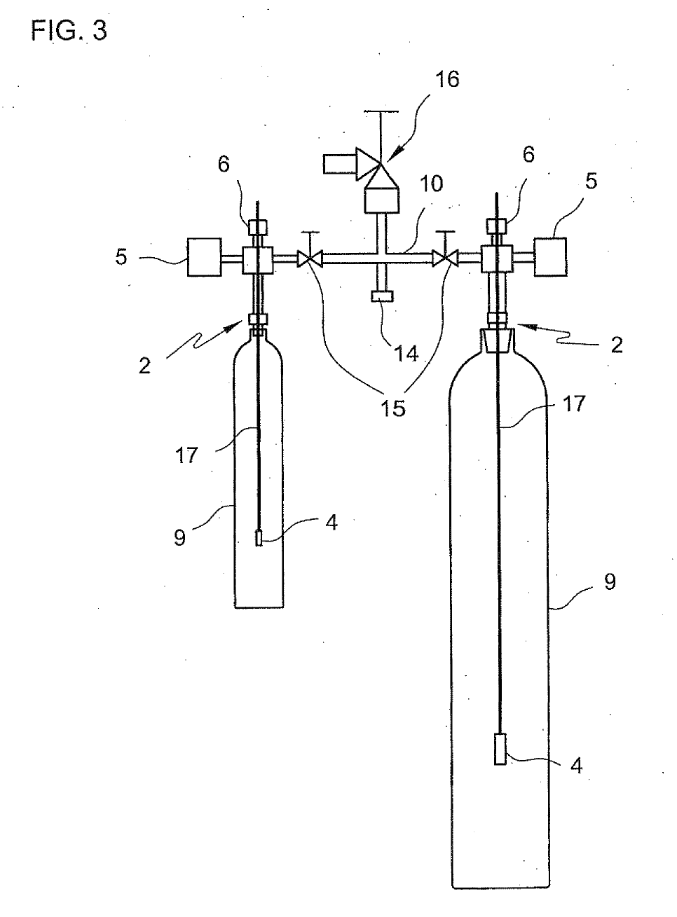

FIG. 3 shows, schematically, a further exemplary embodiment of compressed gas tanks equipped with connectors according to the invention.

FIG. 1 shows one exemplary embodiment of a connector 1 according to the invention for connecting to an opening of a compressed gas tank, comprising a first connection 2 for connecting the connector to a compressed gas tank, a second connection 3 for connecting the connector to a valve head (not shown), with a measurement sensor 4 for determining the temperature and a measurement sensor 5 for determining the pressure being provided. The first connection 2 comprises, in particular, a pin which is provided with an external thread and whose thread communicates with the internal thread of a corresponding compressed gas cylinder. In particular, the second connection 3 has an internal thread which essentially corresponds to the internal thread of a compressed gas cylinder, in such a way that a conventional valve head can be connected to the second connection 3. The first connection 2 can be connected to a conventional compressed gas cylinder such that the first connection 2 is screwed to the corresponding internal thread, in such a way that the measurement sensor 4 for determining the temperature, which extends through the first connection 2, projects into the interior of the compressed gas tank. Other embodiments of the connections 2, 3 are possible and according to the invention.

Furthermore, the connector 1 has a transmission means 6. The transmission means 6 in the present exemplary embodiment is a plug by means of which the measurement sensor 4 for measuring the temperature and/or the measurement sensor 5 for determining the pressure can be connected to an appropriate measurement device (not shown). The connector 1 can be inserted into any desired compressed gas cylinder which can be used as a reference compressed gas tank for the method according to the invention. In particular, this refers to the connector 1 and in particular its lines 7 being designed in a preferred manner such that they have as small a volume as possible. This makes it possible to ensure that the volume of the relevant reference compressed gas tank is changed only slightly so that this results at most in measurement errors whose magnitude is negligible.

The method according to the invention will now be described in detail in particular with reference to FIG. 2. FIG. 2 shows a compressed gas tank 8 which is being filled using the method according to the invention. A reference compressed gas tank 9 is provided in parallel with the compressed gas tank 8. The compressed gas tank 8 and the reference compressed gas tank 9 are connected in parallel to a filling supply line 10. In principle, the designs of the reference compressed gas tank 9 and of the compressed gas tank 8 are identical. The compressed gas tank 8 is provided with a conventional valve head 11. The valve head 11 has two connections 12 by means of which the valve head 11 is connected to the compressed gas tank 8 on one side and to the filling line 10 on the other side. Furthermore, the valve head 11 comprises a valve 13 by means of which the compressed gas tank 8 can be connected for flow purposes to the filling line 10 or to a discharge line, which is not shown here. In contrast to the compressed gas tank 8, the reference compressed gas tank 9 has a connector 1 according to the invention, which is illustrated in detail in FIG. 1 and has been described above. The second connection 3 of the connector 1 is connected to a corresponding valve head 11. The measurement sensor 4 for determining the temperature is in this case fitted to an extension 17, which extends into the reference compressed gas tank 9.

The measurement sensors 4, 5 can be used to determine measurement variables such as the temperature and the pressure in the reference compressed gas tank 9. As an example, the following text describes a filling process comprising a plurality of steps, specifically the production of a two-component gas mixture, although the method according to the invention is not restricted to the mixing of two-component gas mixtures. According to the invention, mixtures of any desired numbers of gas components can thus be produced. At the start of the process, the compressed gas tank 8 and the reference compressed gas tank 9 are evacuated via the filling line 10 until a predeterminable maximum pressure or minimum pressure is reached. The first gas component is then supplied. This is preferably that gas component with the lesser proportion in the final mixture, that is to say whose partial pressure in the final mixture is lower than that of the other component. The filling process takes place with the valves 13 open, in such a way that the gas component can flow through the filling line 10 both into the compressed gas tank 8 and into the reference compressed gas tank 9. The filling line 10 is closed when the pressure to be reached is indicated by means of the measurement sensor 5 for determining the pressure. The filling line 10 is then connected to the other gas component or to a reservoir containing it. In particular, in the second step of the filling process, it is possible to disconnect the reference compressed gas tank 9 from the filling line 10 by operating the appropriate valve 13 of the valve head 11 which is connected to the second connection 3. This results in the compressed gas tank 8 being filled with a second gas component. For example, it is possible to carry out filling with the first gas component up to a pressure of 150 mbar, and then to continue the filling process with the second component up to a pressure of 150 bar or more. Alternatively, it is also possible for the reference compressed gas tank 9 to be connected to the filling line 10 throughout the entire filling process.

Once the compressed gas tank 8 has been filled completely, it is closed and is disconnected from the filling line 10. This can also apply to the reference compressed gas tank 9. A major advantage of the method according to the invention is that the compressed gas tanks used for the compressed gas tank 8 and the reference compressed gas tank 9 are identical. On the one hand, this means that there is no need to carry out any physical modification in order to produce the reference compressed gas tank 9 and on the other hand that any desired compressed gas tank can be used as a reference compressed gas tank. Furthermore, a refinement of the connector 1 according to the invention is possible which fits a multiplicity of compressed gas tanks 9. This is due to the fact that there are a large multiplicity of different compressed gas tanks 8 with different volumes, although they all have an identical thread for connection to a corresponding valve head 11. Since the first connection 2 communicates with an internal thread such as this, it is therefore possible to use a single connector for a multiplicity of different compressed gas tanks, in order to use them as reference compressed gas tanks 9. In this case, it is particularly advantageous for the measurement sensors 4, 5 or the extension 17, which extends through the first connection 2 into the interior of the reference compressed gas tank 9, to be made as short as possible since this then allows use even in small compressed gas tanks 8. In particular, this is not disadvantageous when a pressure measurement is carried out in the low-pressure range since, in the low-pressure range, most gases behave as ideal gases and there is no need to expect stratification effects or the like.

In particular, the extension 17 may be in the form of a riser tube. In this case, it is advantageous for the measurement sensors 5 for determining the pressure to be connected via this extension 17 to the interior of the reference compressed gas tank 9, while the reference compressed gas tank 9 is not evacuated via the extension 17, but alongside the extension 17. This speeds up the process of evacuating the reference compressed gas tank 9.

FIG. 3 shows, schematically, a filling state showing two reference compressed gas tanks 9 of different size. By way of example, it is possible for one of the reference compressed gas tanks 9 to be in the form of a 10-liter compressed gas cylinder, while the second reference compressed gas tank 9 has a volume of 40 liters. Furthermore, the filling device has a connection 14 for connection of a conventional compressed gas cylinder for filling.

Furthermore, valves 15 are provided, by means of which each individual reference compressed gas tank 9 can be disconnected from the filling line 10, or can be connected to it for flow purposes. Furthermore, an inlet valve 16 is provided, by means of which the filling line 10 can be connected to an appropriate gas reservoir and/or to an appropriate evacuation unit. This refinement has the advantage in particular that compressed gas tanks 8 of different size can be filled without having to replace one of the reference gas pressure tanks 9.

The method according to the invention advantageously makes it possible to produce high-precision gas mixtures. In this case, the connector 1 according to the invention can be used particularly advantageously to form a reference compressed gas tank 9 from a conventional compressed gas tank 8, such as a compressed gas cylinder. In particular, measurement sensors 4 for determining the temperature and measurement sensors 5 for determining the pressure, and in this case in particular capacitive pressure sensors, have been found to be advantageous for use as measurement sensors.

### LIST OF REFERENCE SYMBOLS

1 Connector
2 First connection
3 Second connection
4 Measurement sensor for determining the temperature
5 Measurement sensor for determining the pressure
6 Transmission means
7 Line of the connector
8 Compressed gas tank
9 Reference compressed gas tank
10 Filling line
11 Valve head
12 Connection
13 Valve
14 Connection
15 Valve
16 Inlet valve
17 Extension

1. A method for filling at least one compressed gas tank (8) with at least one gas, with a reference compressed gas tank (9) being provided in which a measurement of at least one measurement variable which is relevant for the state in the reference compressed gas tank (9) can be carried out, with the compressed gas tank (8) and the reference compressed gas tank (9) being connected for flow purposes at least at times, with each compressed gas tank (8) and the reference compressed gas tank (9) each having an opening through which they can be filled with a gas and the gas can be removed, with at least one gas being passed during a filling process through the opening into the at least one compressed gas tank (8) and at least at times into the reference compressed gas tank (9), characterized in that a measurement sensor (4, 5) is introduced through the opening into the reference compressed gas tank, and this measurement sensor is used to measure at least one measurement variable at least during a part of the filling process.

2. The method as claimed in claim 1, in which the measurement variable comprises at least one of the following variables:
i) a pressure in the reference compressed gas tank (9);
ii) a temperature in the reference compressed gas tank (9);
iii) a chemical composition of a gas in the reference compressed gas tank (9); and
iv) a moisture content in the reference compressed gas tank (9).

3. The method as claimed in claim 1, in which the measurement sensor is a capacitive pressure measurement sensor.

4. The method as claimed in claim 1, in which the filling process comprises a plurality of steps.

5. The method as claimed in claim 1, in which the filling process is carried out at least at times as a function of the measurement variable.

6. A connector (1) for connection to an opening of a compressed gas tank (8, 9) comprising a first connection (2) for connection of the connector (1) to a compressed gas tank (8, 9), a second connection (2) for connection of the connector (1) to a valve head (11), characterized in that at least one measurement sensor (4, 5) is provided and can be connected for flow purposes at least to the first connection (2).

7. The connector (1) as claimed in claim 6, in which an extension (17) is provided, and extends through the first connection (2).

8. The connector (1) as claimed in claim 7, in which at least one measurement sensor (4, 5) is arranged on the extension (17).

9. The connector (1) as claimed in claim 6, in which at least one of the following measurement sensors (4, 5) is provided:
i) a measurement sensor for determining the pressure in the reference compressed gas tank (9);
ii) a measurement sensor for determining the temperature in the reference compressed gas tank (9);
iii) a measurement sensor for determining a chemical composition of a gas in the reference compressed gas tank (9); and
iv) a measurement sensor for determining a moisture content in the reference compressed gas tank (9).

10. The connector (1) as claimed in claim 9, in which a capacitive pressure measurement sensor is provided.

11. The connector (1) as claimed in claim 6, in which at least one transmission means (6) is provided for transmission of at least one signal from a measurement sensor (4, 5).

12. A compressed gas cylinder valve comprising a connector (1) as claimed in claim 6, and a valve head (11).

13. The connector (1) as claimed in claim 7, in which at least one of the following measurement sensors (4, 5) is provided:
i) a measurement sensor for determining the pressure in the reference compressed gas tank (9);
ii) a measurement sensor for determining the temperature in the reference compressed gas tank (9);
iii) a measurement sensor for determining a chemical composition of a gas in the reference compressed gas tank (9); and
iv) a measurement sensor for determining a moisture content in the reference compressed gas tank (9).

14. The connector (1) as claimed in claim 8, in which at least one of the following measurement sensors (4, 5) is provided:
i) a measurement sensor for determining the pressure in the reference compressed gas tank (9);
ii) a measurement sensor for determining the temperature in the reference compressed gas tank (9);
iii) a measurement sensor for determining a chemical composition of a gas in the reference compressed gas tank (9); and
iv) a measurement sensor for determining a moisture content in the reference compressed gas tank (9).

15. The connector (1) as claimed in claim 7, in which at least one transmission means (6) is provided for transmission of at least one signal from a measurement sensor (4, 5).

16. The connector (1) as claimed in claim 8, in which at least one transmission means (6) is provided for transmission of at least one signal from a measurement sensor (4, 5).

17. A compressed gas cylinder valve comprising a connector (1) as claimed in claim 7, and a valve head (11).

18. A compressed gas cylinder valve comprising a connector (1) as claimed in claim 8, and a valve head (11).

19. The method as claimed in claim 2, in which the measurement sensor is a capacitive pressure measurement sensor.

20. The method as claimed in claim 2, in which the filling process is carried out at least at times as a function of the measurement variable.
